(19) United States
(12) Patent Application Publication
(10) Pub. No.: US 2010/0264005 A1
(43) Pub. Date: Oct. 21, 2010

(54) KEYPAD ASSEMBLY AND PORTABLE ELECTRONIC DEVICE USING SAME

(75) Inventors: MEI-TSU TSAO, Tu-Cheng (TW); YEN-WEN HUANG, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/488,718

(22) Filed: Jun. 22, 2009

(30) Foreign Application Priority Data
Apr. 21, 2009 (CN) 200910301716.4

(51) Int. Cl. H01H 13/76

(52) U.S. Cl. 200/5 A

(57) ABSTRACT

A keypad assembly includes a pressing cover, a pressing body, a printed circuit board, and a support member. The pressing cover includes a plurality of pressing caps. The pressing body includes a plurality of keys respectively mounted to the pressing caps and a deformable area surrounding the keys. The printed circuit board includes a plurality of contacting sheets. The contacting sheets are respectively aligned with the keys. The support member is mounted between the pressing body and the printed circuit board. The support member includes a plurality of support beams. The support beams are mounted to the deformable area and separate adjacent contacting sheets and keys from each other.

### BACKGROUND

1. Technical Field

The present disclosure relates to keypad assemblies and, particularly, to a keypad assembly used in a portable electronic device.

2. Description of Related Art

Keypad assemblies used in portable electronic devices such as mobile phones and personal digital assistants (PDAs) are becoming smaller and thinner.

A typical keypad assembly includes a printed circuit board (PCB), a pressing cover, a pressing body having elastic beams for connecting with pressing buttons, and a mounting frame. However, the mounting frame increases the thickness of the keypad assembly. Furthermore, the elastic beam typically has a long size to ensure its deformability, thus further increasing a related size of the keypad assembly.

Therefore, there is room for improvement within the art.

### BRIEF DESCRIPTION OF THE DRAWINGS

Many aspects of the keypad assembly can be better understood with reference to the following drawings. These drawings are not necessarily drawn to scale, the emphasis instead being placed upon clearly illustrating the principles of the present keypad assembly. Moreover, in the drawings like reference numerals designate corresponding sections throughout the several views.

FIG. 1 is an isometric, exploded view of a keypad assembly, in accordance with an exemplary embodiment.

FIG. 2 is an isometric view of a pressing body shown in FIG. 1.

FIG. 3 is an isometric, assembled view of the keypad assembly shown in FIG 1.

FIG. 4 is a cross-sectional view of the keypad assembly.

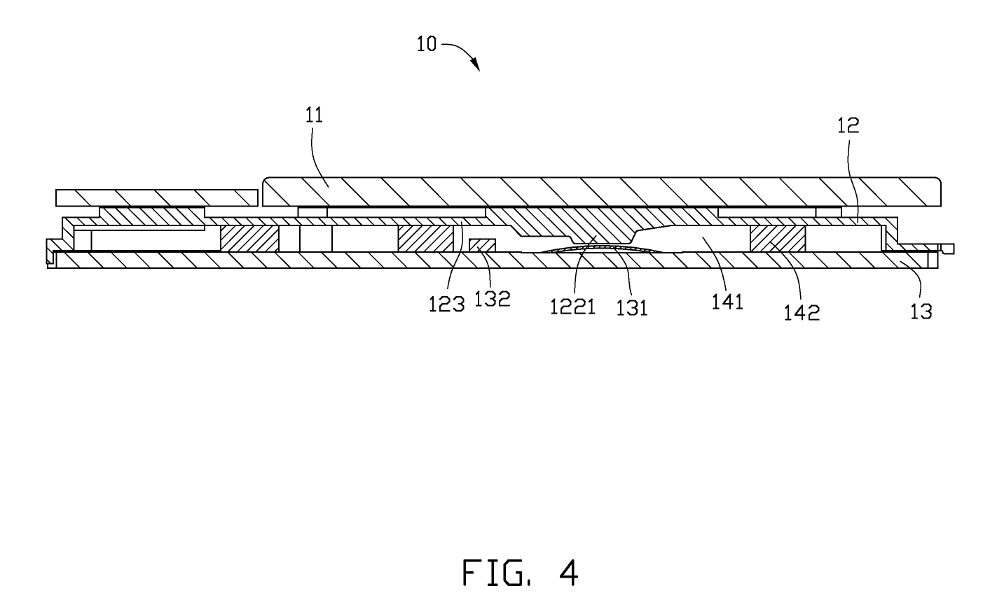

FIG. 5 is a schematic view showing the use of the keypad assembly.

### DETAILED DESCRIPTION

The present keypad assembly is suitable for use in a portable electronic device, e.g., mobile phone and personal digital assistant (PDA).

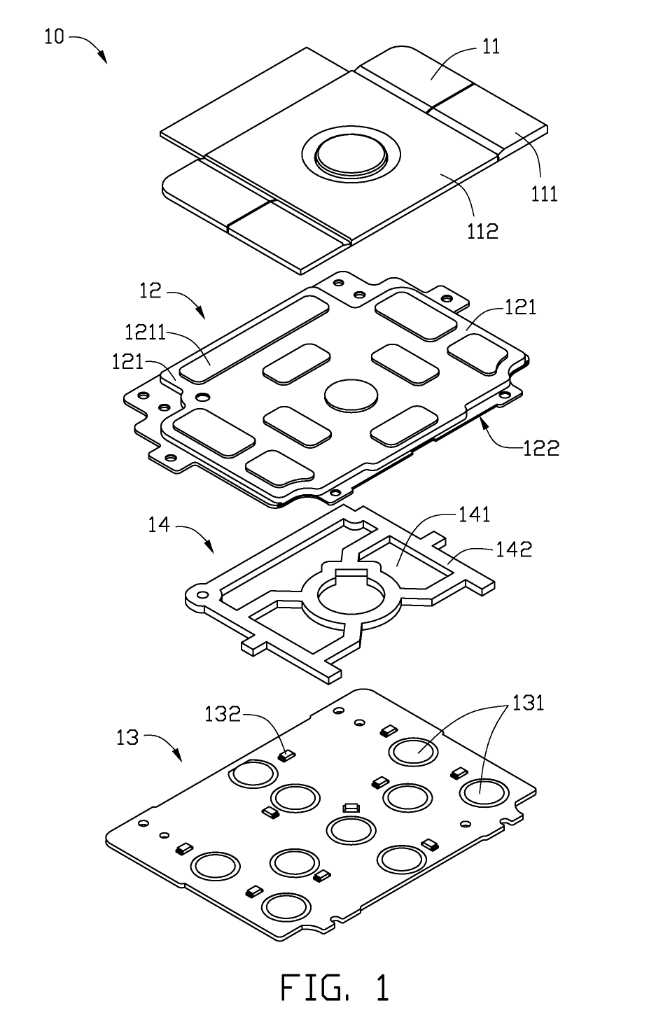

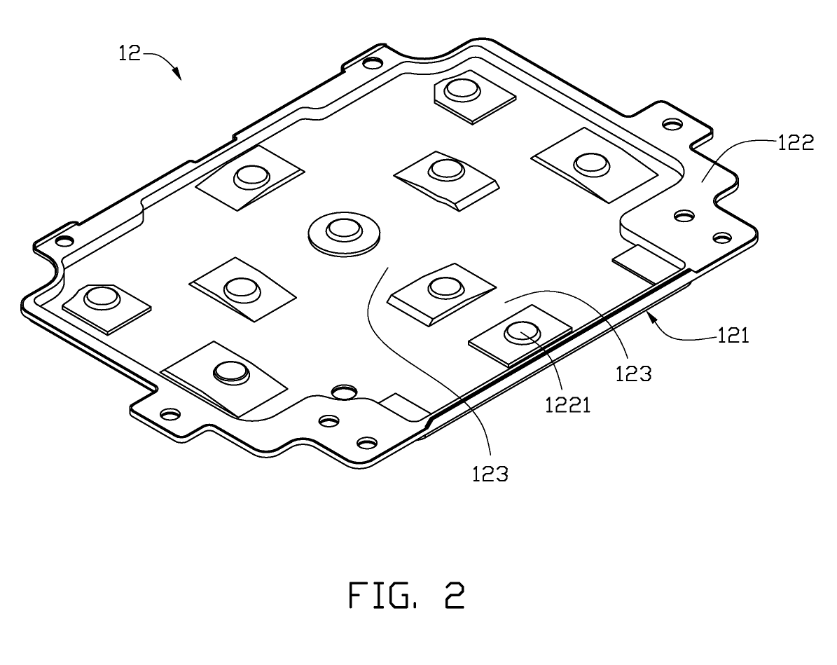

Referring to FIGS. 1 and 2, an exemplary keypad assembly 10 includes a pressing cover 11, a pressing body 12, a printed circuit board 13 and a support member 14. The pressing cover 11 is integral with the pressing body 12. The pressing body 12 is connected to the support member 14, and aligned with the printed circuit board 13.

The pressing cover 11 can have any shape and is used to be pressed by a user. The pressing cover 11 includes a plurality of pressing caps, e.g., a plurality of first pressing caps 111 and a second pressing cap 112. The first pressing caps 111 surround the second pressing cap 112. The second pressing cap 112 is a multi-directional pressing cap. The first pressing caps 111 and the second pressing cap 112 are printed with symbols, e.g., letters, figures, and etc. The pressing cover 11 is formed by ploycarbonate (PC) injecting.

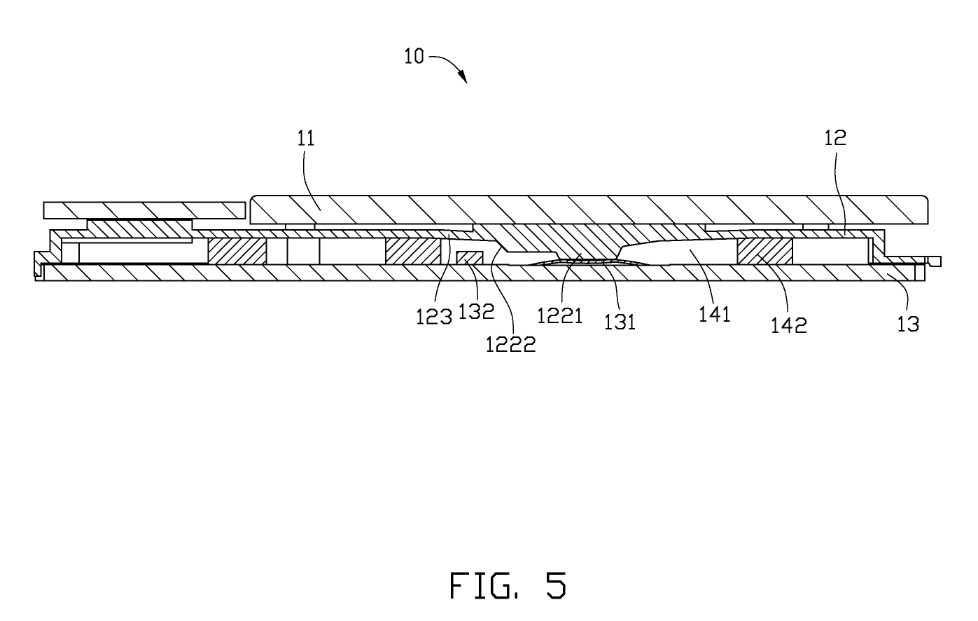

The pressing body 12 is made of elastic material. In this embodiment, the pressing body 12 is generally rectangular shaped. The pressing body 12 includes a main board 121, and a plurality of keys 122. Each key 122 includes a mounting portion 123 and a pressing button 125 respectively protruding from opposite surfaces of the main board 121. The mounting portions 123 are arranged corresponding to the arrangement of the pressing caps 111, 112 to be respectively mounted to the pressing caps 111, 112. The pressing buttons 125 are arranged corresponding to the mounting portions 123, and used to contact the printed circuit board 13. Each pressing button 125 has a light-guiding surface 1251 (as shown in FIG. 5). The main board 121 further includes a deformable area 126 surrounding the keys 122. The deformable area 126 is fixed to the support member 14, thus mounting the pressing cover 11 and the pressing body 12 to the support member 14. The deformable area 126 has a thickness smaller than that of the mounting portions 123 and the pressing buttons 125, thus making the deformable area 126 have a substantial deformability. The deformable area 126 can rebound to drive the pressing buttons 125 back to their own previous positions.

The printed circuit board 13 includes a plurality of elastic contacting sheets 131 and lamps 132. Each lamp 132 is arranged adjacent to a corresponding contacting sheet 131. In the exemplary embodiment, the lamps 132 are light emitting diodes (LEDs). Each pressing button 125 is aligned with and spaced from the corresponding contacting sheet 131.

The support member 14 is generally a frame. The support member 14 includes a plurality of receiving cavities 141, and a plurality of support beams 142. The receiving cavities 141 are arranged corresponding to the keys 122 of the pressing body 12. The support beams 142 connect each other, surrounding the receiving cavities 141. The support member 14 is sandwiched between the pressing body 12 and the PCB 13. Each receiving cavity 141 receives a corresponding pressing button 125, a corresponding contacting sheet 131, and a corresponding lamp 132 therein. One end of each support beam 142 abuts against the PCB 13, the other end abuts against the deformable area 126, thus separating adjacent pressing buttons 125, contacting sheets 131, and lamps 132. The support member 14 is made of opaque and elastic material, e.g., ducked cotton.

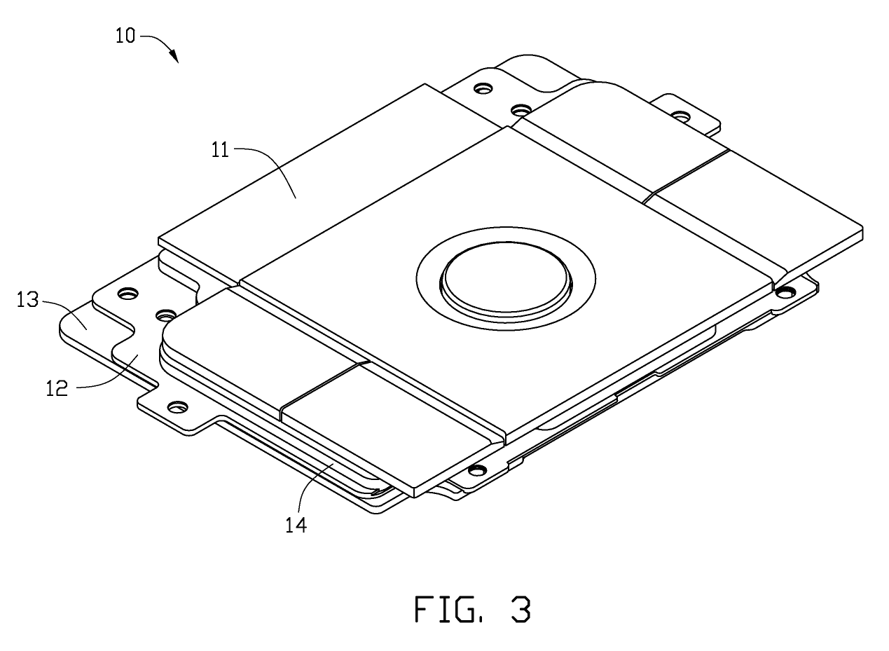

Referring to FIGS. 3 and 5, in assembly, the pressing cover 11 is fixed to the pressing body 12. The support member 14 is mounted to the PCB 13, with each receiving cavity 141 receiving a corresponding contacting sheet 131 and lamp 132 therein and each light-guiding surface 1251 facing a corresponding lamp 132. The pressing body 12 is placed above the support member 14, with the deformable area 126 abutting against the support beams 142 of the support member 14. In such, the receiving cavity 141 with the pressing caps 111, 112 mounted therein can prevent leaking of light emitted from the lamps 132. Furthermore, the light-guiding surface 1251 can guide light irradiated by one of the lamps 132 disposed at one side of a pressing button 125 to the other side of the pressing button 125, to make the light emitting out of the pressing cover 11 more uniform.

In use, when a pressing cap 111 or 112 is pressed, the support beams 142 and the deformable area 126 connected to the corresponding pressing button 125 will be elastically stretched. Thus, the pressing button 125 moves towards the corresponding contacting sheet 131 of the PCB 13, until the pressing button 125 presses the contacting sheet 131 to trigger an input signal. Then the pressing cover 11 is released, the support beams 142 and the deformable area 126 rebound and drive the pressing cover 11 to resume to its previous shape. While the pressing cover 11 is pressed, the support beams 142 also slightly deforms, thus reinforcing elastic force of the deformable area 126. Therefore, a smaller deformable area 126 can be used for the keypad assembly 10, thus minimizing the related size of the keypad assembly 10. Furthermore, the support member 14 is located between the pressing body 12 and the printed circuit board 13, further reducing the thickness of the keypad assembly 10.

It is to be understood, however, that even through numerous characteristics and advantages of the present disclosure have been set forth in the foregoing description, together with details of the structure and function of the disclosure, the disclosure is illustrative only, and changes may be made in detail, especially in matters of shape, size, and arrangement of sections within the principles of the disclosure to the full extent indicated by the broad general meaning of the terms, in which the appended claims are expressed.

What is claimed is:

1. A keypad assembly comprising:
a pressing cover including a plurality of pressing caps;
a pressing body including a plurality of keys respectively mounted to the pressing caps and a deformable area surrounding the keys;
a printed circuit board including a plurality of contacting sheets, the contacting sheets being respectively aligned with the keys; and
a support member mounted between the pressing body and the printed circuit board, the support member including a plurality of support beams, the support beams mounted to the deformable area and separating adjacent contacting sheets and keys from each other.

2. The keypad assembly as claimed in claim 1, wherein the support member is generally a frame, the support member defines a plurality of receiving cavities, forming the support beams.

3. The keypad assembly as claimed in claim 2, wherein each key includes a mounting portions and a pressing button, the mounting portion and the pressing button protrude from opposite surfaces of the pressing body, the mounting portions are arranged corresponding to the arrangement of the pressing caps to be respectively mounted to the pressing caps, the pressing buttons are arranged corresponding to the mounting portions, and used to press contacting sheets.

4. The keypad assembly as claimed in claim 1, wherein the support member is made of opaque material.

5. The keypad assembly as claimed in claim 2, wherein the support member is made of elastic material.

6. The keypad assembly as claimed in claim 1, wherein the support member is made of ducked cotton.

7. The keypad assembly as claimed in claim 3, wherein the printed circuit board includes a plurality of lamps, a lamp is adjacent to each contacting sheet.

8. The keypad assembly as claimed in claim 7, wherein each pressing button has an inclined light-guiding surface, each light-guiding suface faces a corresponding lamp.

9. A portable electronic device incorporated with a keypad assembly, the keypad assembly comprising:
a pressing cover including a plurality of pressing caps;
a pressing body including a plurality of keys respectively mounted to the pressing caps and a deformable area surrounding the keys;
a printed circuit board including a plurality of contacting sheets, the contacting sheets being respectively aligned with the keys; and
a support member mounted between the pressing body and the printed circuit board, the support member including a plurality of support beams, the support beams mounted to the deformable area and separating adjacent contacting sheets and keys from each other.

10. The keypad assembly as claimed in claim 9, wherein the support member is generally a frame, the support member defines a plurality of receiving cavities, forming the support beams.

11. The keypad assembly as claimed in claim 10, wherein each key includes a mounting portion and a pressing button, the mounting portion and the pressing button protrude from opposite surfaces of the pressing body, the mounting portions are arranged corresponding to the arrangement of the pressing caps to be respectively mounted to the pressing caps, the pressing buttons are arranged corresponding to the mounting portions, and used to press contacting sheets.

12. The keypad assembly as claimed in claim 9, wherein the support member is made of opaque material.

13. The keypad assembly as claimed in claim 9, wherein the support member is made of elastic material.

14. The keypad assembly as claimed in claim 9, wherein the support member is made of ducked cotton.

15. The keypad assembly as claimed in claim 11, wherein the printed circuit board includes a plurality of lamps, a lamp is adjacent to each contacting sheet.

16. The keypad assembly as claimed in claim 15, wherein each pressing button has an inclined light-guiding surface, each light-guiding suface faces a corresponding lamp.

17. A keypad assembly comprising:
a pressing body including a plurality of keys and a deformable area surrounding the keys;
a printed circuit board including a plurality of contacting sheets, the contacting sheets being respectively aligned with the keys; and
a support member mounted between the pressing body and the printed circuit board, the support member including a plurality of support beams, the support beams mounted to the deformable area and separating adjacent contacting sheets and keys from each other.

18. The keypad assembly as claimed in claim 17, further comprising a pressing cover, wherein the pressing cover including a plurality of pressing caps, the keys are respectively mounted to the pressing caps.
